(19) United States
(12) Patent Application Publication
(10) Pub. No.: US 2023/0001364 A1
(43) Pub. Date: Jan. 5, 2023

(54) DISAGGREGATION, STABILIZATION AND SURFACE ENGINEERING OF NANODIAMONDS FOR SURFACE ATTACHMENTS

(71) Applicant: BAR-ILAN UNIVERSITY, Ramat Gan (IL)

(72) Inventors: Jean-Paul LELLOUCHE, Ashdod (IL); Daniel ITSHAK, Tel Aviv (IL); Yifat HAREL, Holon (IL); Limor Liron ISRAEL, Modiin (IL); Esthy LEVY-EITAN, Givat Shmuel (IL)

(21) Appl. No.: 17/777,447

(22) PCT Filed: Nov. 26, 2020
(86) PCT No.: PCT/IL2020/051218

§ 371 Date: May 17, 2022

Related U.S. Application Data
(60) Provisional application No. 62/940,267, filed on Nov. 26, 2019.

(51) Int. Cl. B01F 31/80; C01B 32/28

(52) U.S. Cl. CPC B01F 31/80; C01B 32/28; C01P 2004/64; C01P 2006/22; C01P 2002/82; C01P 2004/03; C01P 2004/04; C01P 2002/88

(57) ABSTRACT

A disaggregation method for NDs (nanodiamonds) comprising: sonicating NDs dispersed in water; and sedimenting non-disaggregated NDs by centrifugation. Optionally, the method includes sonicating the disaggregated NDs with CAN [(NH₄)₂Ce(NO₃)₆] to produce CAN modified NDs and washing to remove excess CAN. Populations of disaggregated NDs are also disclosed. In some embodiments the populations are provided as an aqueous suspension.

### FIELD OF THE INVENTION

The various described embodiments are in the field of nanodiamonds.

### BACKGROUND OF THE INVENTION

Carbon is the fourth most abundant chemical element in the universe after hydrogen, helium, and oxygen. It is a Block P, Period 2, nonmetallic element. The well-known forms of carbon are diamond, graphite and amorphous carbon. Modeling of new carbon allotropes is known and the SACADA (Samara Carbon Allotrope Database) has registered more than 500 hypothetical allotropes.

Carbon-based nanostructures are a group of promising materials for various technologies, biotechnologies, and medicine. Carbon-based nanostructures are used for coating biomaterials designed for hard tissue implantation, biosensors and drug delivery systems. The most famous allotropes used in nanotechnology are nanodiamonds (NDs), graphite and various crystallographic structures of fullerene.

Carbon-based nanomaterials can be toxic and their toxicity is particle size-dependent. Cytotoxicity is enhanced when the surface of the particles is functionalized after an acidic treatment. The mechanisms of toxicity include oxidative stress, inflammatory responses, malignant cell transformation, DNA damage and mutation, formation of granulomas, and interstitial fibrosis.

As nanoparticles of graphite, graphene, and fullerenes are well known, NDs give rise to more and more publications each year, for very diverse purposes. As suggested by their name, NDs are Nano-scaled diamonds, i.e. diamonds with a size smaller than 100 nm.

Despite their chemical identity, there are differences between a diamond and a Nano-diamond.

A diamond is an assembly of sp3 hybridized carbon atoms, ordered in a very stable face-centered cubic crystal structure. Diamonds are famous for their physical qualities, most of which originate from the strong covalent bonding between its carbon atoms. Due to their thermodynamic stability, diamonds are inert towards any chemical reaction.

In contrast, NDs are more prone to react with other materials for two main reasons. The first reason is that being small particles (4-10 nm), NDs have a very large surface area. The second reason is that NDs are covered by a shell of reactive impurities: mostly non-sp3 carbons, but also diverse functional groups. The nature and the quantity of these functional groups depend on the fabrication method, and on the confinement conditions of the product.

There are several techniques for turning carbon into its allotropic diamond and tons of artificial diamonds are fabricated every year. Some of the techniques are: plasma assisted chemical vapor deposition (CVD), autoclave synthesis from supercritical fluids, and electron irradiation of carbon ‘onions’. In the artificial diamond industry, the three main methods used are detonation, laser ablation, and high-pressure high-temperature.

Synthesis of NDs by detonation is used to produce the majority of the synthetic NDs in the world. NDs produced by detonation are referred to as dNDs. In the detonation method, explosives are detonated in a closed metallic chamber under N₂, CO₂ and H₂O atmosphere. After detonation, diamond-containing soot is collected from the bottom and the walls of the chamber and purified by oxidation to remove non-diamond carbons, followed by an HCl treatment to remove non-carbon impurities. The detonation process relies on the fact that graphite is the most stable phase of carbon at low pressures, and diamond—at high pressures. Both phases melt when the temperature reaches 4,500 K. For Nano-scaled carbon, the liquid-solid transition can be reached at lower temperatures. During detonation, the pressure and temperature rise instantaneously, reaching the region of liquid carbon and clusters of 1-2 nm are formed. The nanoclusters further coalesce into larger liquid droplets and crystallize to nanoparticles. As long as the reaction stays above the diamond—graphite equilibrium line, only diamond particles are formed.

NDs share some important properties with diamonds including chemical stability, superior hardness (Young's modulus of 1050-1210 GPa), specific optical properties and fluorescence, high thermal conductivity and electrical resistivity, chemical stability, and resistance to extreme contact conditions.

NDs have been studied both in vitro and in vivo. NDs have low pulmonary toxicity and intravenously administered Nanodiamond complexes at high dosages do not change serum indicators of liver and systemic toxicity. In general, NDs are biocompatible.

Unlike diamonds, NDs tend to bind together into stable aggregates. NDs aggregate into clusters of diamond nanoparticles surrounded by impurities, such as graphene and soot, perhaps due to the high hydrophobicity of dNDs surface.

NDs are commonly used as abrasives, binders for tools, lubricants, metal-ND coating agents, bulk composites, and polymer film coatings. Known surface treatments of NDS include homogenization by treatment with strong acids and/or by hydrogenation, carboxylation (often as an intermediate step in further modification).

NDs have a truncated Octahedron Structure which makes them promising candidates for drug delivery. Molecules of different characters can be attached to different facets of the ND, making it ideal for delivery of multifunctional drugs, or as solubility agents of non-soluble molecules. Sustained release of a drug can be achieved by binding its molecules to the surface through linkers with different affinities. Out of all carbon allotropes, NDs have the highest cell uptake efficiency. Moreover, cell uptake efficiency is tunable by altering the size and charge of the particle. NDs are also used as bioanalytical tools for chromatography, solid phase sorbents for detoxification and separation [26], biochips and sensors.

### SUMMARY OF THE INVENTION

One aspect of some embodiments of the invention relates to creating stable dispersions of NDs. In some embodiments the dispersions are in water or another aqueous medium.

Another aspect of some embodiments of the invention relates to attaching active groups to the surface of NDs. In some embodiments the active groups are CAN [(NH₄)₂Ce(NO₃)₆]. Alternatively or additionally, in some embodiments the active groups are organic active groups (e.g. PEI and/or HA).

It will be appreciated that the various aspects described above relate to solution of technical problems associated with reducing aggregation of NDs in an aqueous suspension.

Alternatively or additionally, it will be appreciated that the various aspects described above relate to solution of technical problems related to increasing binding efficiency of various ligands to NDs.

Alternatively or additionally, it will be appreciated that the various aspects described above relate to solution of technical problems related to using NDs as a delivery vehicle in a biological system.

In some exemplary embodiments of the invention there is provided a disaggregation method for NDs (nanodiamonds) comprising: (a) sonicating NDs dispersed in water; and (b) sedimenting non-disaggregated NDs by centrifugation. In some embodiments the centrifugation is at 20000 RCF for at least 10 minutes. Alternatively or additionally, in some embodiments the method includes sonicating the disaggregated NDs with CAN [(NH₄)₂Ce(NO₃)₆] to produce CAN modified NDs; and washing to remove excess CAN.

In some exemplary embodiments of the invention there is provided a population of CAN modified NDs having a size of 10-20 nm. In some embodiments the population of CAN modified NDs is provided as a clear dispersion in water. Alternatively or additionally, in some embodiments the population of CAN modified NDs is characterized by ζ-potential (zeta potential) of +35mV to +50 mV. Alternatively or additionally, in some embodiments the NDs comprise dNDs (detonation nanodiamonds). Alternatively or additionally, in some embodiments the NDs comprise natural NDs.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Percentages (%) are W/W (weight per weight) unless otherwise indicated.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a plot of absorbance as a function of wavelength in (cm⁻) for SA-dNDs, GROX-dNDs and OX-dNDs;

FIG. 2 is a plot of intensity as a function of Raman shift in (cm⁻¹) for SA-dNDs, GROX-dNDs and OX-dNDs;

FIG. 3 is a bar graph of zeta potential in my for SA-dNDs, GROX-dNDs and OX-dNDs;

FIG. 4 is a bar graph of DLS size in (dnm) for SA-dNDs, GROX-dNDs, OX-dNDs, Ultra dNDs and UC-dNDs showing average and standard deviation;

FIG. 5 is a plot of Percent weight (%) as a function of temperature (° C.) for SA-dNDs and f-NDs;

FIG. 6 is a plot of Percent weight (%) as a function of temperature (° C.) for CAN;

FIG. 7 is a bar graph of Nitrogen % for SA-dNDs, f-dNDs-2a, f-dNDs-1a, f-dNDs-3a, f-dNDs-1b and f-dNDs-2b;

FIG. 8 is a is a bar graph of zeta potential in my for SA-dNDs, f-dNDs-1b, f-dNDs-2b, f-dNDs-1c and f-dNDs-2c;

FIG. 9 is a is a bar graph of Cerium % for SA-dNDs, f-dNDs-1b, f-dNDs-2b and f-OX-dNDs-1b showing average and standard deviation;

FIG. 10 is HR-SEM images of pristine dNDs (a) and f-dNDs-2b (b);

FIG. 11 is a photograph of a vial containing a clear solution of CAN-modified dNDs with NPs produced by the ultrasonication-centrifugation technique (left) and a vial of a solution of CAN-modified dNDs from non-disaggregated dNDs (right) with a pink syringe filter placed behind the vials;

FIG. 12 is a Pareto chart of the DoE for zeta-potential;

FIG. 13 is a main effect plot for zeta-potential;

FIG. 14 is a Pareto chart for DLS size;

FIG. 15 is a main effect plot for Ce concentration;

FIG. 16 is a series of 4 HR-TEM micrographs of f-UC-dNDs-PEI25, 15-40 nm dND aggregates attached to b-PEI25; dNDs are indicated by arrow (C), cerium is indicated by arrow (B), and PEI is indicated by arrow (A);

FIG. 17 is a plot of FTIR spectra (Absorbance as a function of wavenumber in cm⁻¹) for bPEI25 (top), UC-dNDs-bPEI25 (middle), and f-UC-dNDs-bPEI25 (bottom);

FIG. 18 is a TGA curve (Mass % as a function of temperature in ° C.) illustrating PEI attachment to dNDs with (f) and without CAN; and

FIG. 19 is a TGA curve (Mass % as a function of temperature in ° C.) illustrating HA attachment to dNDs with (f) and without CAN.

### DETAILED DESCRIPTION OF EMBODIMENTS

Embodiments of the invention relate to methods for disaggregation of nanodiamonds (NDs) and resultant suspensions of disaggregated NDs.

Specifically, some embodiments of the invention can be used to attach one or more functional groups to the disaggregated NDs.

The principles and operation of a method and/or suspension according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### Exemplary Method

In some exemplary embodiments of the invention there is provided a disaggregation method for NDs (nanodiamonds) including sonicating NDs dispersed in water and sedimenting non-disaggregated NDs by centrifugation. Details of exemplary sonication protocols are provided hereinbelow. In some exemplary embodiments of the invention, the centrifugation is at 20000 RCF for at least 10 minutes.

In some exemplary embodiments of the invention, the method includes sonicating the disaggregated NDs from the supernatant with CAN [(NH₄)₂Ce (NO₃)₆] to produce CAN modified NDs and washing to remove excess CAN.

### Exemplary Product

In some exemplary embodiments of the invention there is provided a population of CAN modified NDs having a size of 10 nm to 20 nm. According to various exemplary embodiments of the invention 80%, 85%, 90%, 95%, 97.5%, 99%, or 99.5% or intermediate or greater percentages of the particles of the population fall within the 10 nm to 20 nm size range.

In some exemplary embodiments of the invention, the population of CAN modified NDs according is provided as a clear dispersion in water. According to various exemplary embodiments of the invention the dispersion is stable (i.e. remains clear) for at least 1 hour, at least v4 hours, at least 12 hours, at least 1 day, at least 5 days, at least 10 days or at least 20 days or intermediate or greater amounts of time.

Alternatively or additionally, in some embodiments the population of CAN modified NDs according is characterized by ζ-potential (zeta potential) of +35mV to +50 mV.

Exemplary ND Sources

According to various exemplary embodiments of the invention the NDs of the method and/or population include dNDs (detonation nanodiamonds) and/or synthetic NDs from other sources and/or natural NDs.

### Exemplary Use Scenarios

In some exemplary embodiments of the invention, the disaggregated NDs described in this application serve as nanoparticle delivery vehicles for active agents in biological systems. For example, the experimental examples herein below demonstrate that pretreatment of NDs with an inorganic surface agent such as CAN contributes at an ability of the NDs to bind organic compounds (e.g. PEI and/or HA). NDs surface treated with CAN are expected to find utility in a wide variety of biotechnology and/or medical applications. For example, the CAN treated NDs can be used for coating biomaterials designed for hard tissue implantation, biosensors and drug delivery system.

In some exemplary embodiments of the invention, molecules of different types attached to different facets of the ND as a way to deliver multifunctional drugs, or as solubility agents for non-soluble molecules. Alternatively or additionally, in some embodiments sustained release of a drug is achieved by binding drug molecules to the ND surface using linkers with different affinities. Out of all carbon allotropes, NDs have the highest cell uptake efficiency. Moreover, cell uptake efficiency is tunable by altering the size and charge of the ND particles.

In some exemplary embodiments of the invention, multiple chemical moieties are attached to an ND. For example, the experimental examples hereinbebolow demonstrate attachment of CAN to NDs followed by attachment of PEI. In some embodiments PEI serves as a vehicle for further attachment of biologic molecules (e.g. RNA and/or DNA).

In some embodiments Hyaluronic acid serves as a ligand for coordinative chemistry, especially in it conjugate base (Hyaluronate) form. Hyaluronic Acid is an important ingredient in many cosmetics. Since NDs are characterized by high dermal absorption, they could potentially improve penetration of existing creams to the skin.

According to various exemplary embodiments of the invention CAN treated NDs serve as delivery vehicles for drugs and/or genes and/or proteins. It is expected that during the life of this patent many sources of nanodiamonds will be developed and the scope of the invention is intended to include all such new technologies a priori.

As used herein the term “about” indicates ±10%.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Alternatively or additionally, various exemplary embodiments of the invention exclude any specific feature, part, component, module, process or element which is not specifically disclosed herein.

Specifically, the invention has been described in the context of CAN but might also be used to attach other inorganic surface modifiers to NDs.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

Additional objects, advantages, and novel features of various embodiments of the invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions; illustrate the invention in a non-limiting fashion.

The following materials and methods are used in performance of experiments described in examples hereinbelow:

### Materials

CAN: (Acros Organics B.V.B.A.) An inorganic complex with the following chemical formula (NH₄)₂Ce(NO₃)₆. This orange-red, water-soluble cerium nitrate salt consists of the anion [Ce(NO₃)₆]²⁻ and a pair of NH₄⁺ counter ions.

dNDs: (SIGMA-ALDRICH®; Rehovot, Israel) Diamond nanopowder, <10 nm particle size (TEM), ≥95% trace metals basis. Although <10 nm diameter NDs were purchased, analysis of the starting batch (DLS, SEM, and TEM) revealed that size of the aggregates varied from 100 nm up to 1500 nm. HR-TEM image shows crystalline 4-8 nm dNDs surrounded by amorphous carbon.

Polyethylenimine (b-PEI25): (SIGMA-ALDRICH®; Rehovot Israel) average Mw ˜25000 by LS, average Mn ˜10000 by GPC.

Hyaluronic Acid: HA Mw=799.641 g/mol (SIGMA-ALDRICH®; Rehovot Israel)

### Methods

### Sample Preparation

The sample names and their corresponding preparation conditions are summarized in Table 1. Detailed procedures will follow.

TABLE 1
Samples and preparation methods

| Sample Name | Preparation conditions |
|---|---|
| SA-NDs | Pristine dNDs purchased from Sigma-Aldrich ® |
| Grax-NDs | Graphitized-Oxidized dNDs |
| Ox-NDs | Oxidized dNDs |
| Ultra-NDs | Ultra-sonicated dNDs |
| UC-dNDs | Ultra-sonicated - centrifuged dNDs |
| f-NDs-2a | SA-NDs; CAN in acetone; 60 min US; 20% amplitude |
| f-NDs-1a | SA-NDs; CAN in acetone; 30 min US; 30% amplitude |
| f-NDs-3a | SA-NDs; CAN in acetone; 60 min US; 30% amplitude |
| f-NDs-1b | SA-NDs; CAN in water; 30 min US; 25% amplitude |
| f-NDs-2b | SA-NDs; CAN in water; 30 min US; 25% amplitude |
| f-NDs-1c | SA-NDs; CAN in water 10 min; Microwave irradiation; |
| | 150° C. |
| f-NDs-2c | SA-NDs; CAN in water 10 min; Microwave irradiation; |
| | 180° C. |
| f-Ox-NDs-1b | Ox dNDs; CAN in water; 60 min US; 25% amplitude |
| f-Ox-NDs-2a | Ox dNDs; SA-NDs; CAN in water; 30 min US; 25% |
| | amplitude |

Disaggregation: ultra-dispersed particles of NDs agglomerate into stable clusters. In order to make the individual ND surfaces available for coating an initial disaggregation step was implemented. Four disaggregation methods were tested.

Disaggregation by Ultrasonication: 5 mg of detonation NDs (dNDs) were dispersed in 10 ml ddH2O in a three-neck probe-ultrasonication vessel and placed in an ultrasonicator under a nitrogen atmosphere (to avoid air oxidation) for 1 hour/30% Amplitude.

Disaggregation by Oxidation: It has been reported that oxidation by heat decreased dND aggregates size to approximately 50 nm diameter. Based on this, 10 mg of dNDs were placed in a furnace at 620° C. for 2 hours.

Disaggregation by Graphitization-Oxidation: Following another published protocol, 10 mg of detonation NDs were heated at 900° C. under nitrogen for 1 hour, then under air at 450° C. for 2 hours.

Disaggregation by Ultrasonication-Centrifugation: The rationale behind this method is the rapid re-aggregation of dNDs. The idea was to first break the aggregates using the colliding effect produced by sonication, and then to sediment the remaining aggregates by centrifugation. 10 mg of dNDs were dispersed in 30 ml of ddH₂O and sonicated in an ultrasonicator for 30 min (40% amplitude). The solution was then directly placed in a centrifuge for 10 min (20000 RCF, −2° C.). The apparatus used for sonication is a VIBRACELL VC 750 /750 watts·250 μl—liters with a high gain 13 mm probe. Subsequent testing suggests that 30% amplitude provides similar results.

### Inorganic Surface Modification:

For the inorganic surface modification of dNDs by CAN, two methods were tested:

Inorganic surface modification by Ultrasonication: 25 mg of dND were dispersed in 15 ml acetone or ddH₂O in a sonication bath for 10 min. 82.5 mg CAN were then added and the solution was transferred into a 3 neck sonication vessel. The reaction vessel was placed in a finger probe ultrasonicator (high-power ultrasonicator) for variable durations and amplitude magnitudes.

Inorganic surface modification by Microwave irradiation: 8.33 mg of ND were dispersed in 5 ml ddH₂O in a sonication bath for 10 min. 27.5 mg CAN were added and the solution was transferred into a 5 ml special microwave vial and placed in the MW (Biotage initiator +) for 10 min/150° C. or 180° C.

In both methods, excess of unbound CAN was washed with ddH2O: pouring the solution into a centrifugal-filter tube (100,000 KDa) and centrifuging for five cycles (4,000 rpm, 18° C., 5 min). The final content of the filter was divided in two; one half was kept in its liquid phase and the other half was lyophilized, resulting in a beige-greyish powder.

### Second-Step Surface-Modification

For the subsequent organic surface modification of dNDs, two methods were tested:

Attachment of polyethylenimine (PEI): 110 mg of PEI were dissolved in 30 ml of ddH₂O. The solution was mixed in a VortexGenie2 automatic stirrer. 3 ml of the solution were added to a solution of dND-CAN (15 ml solution [dND]=1.06 g·L⁻¹). The solution containing dND-CAN NPs and PEI was mixed for 1H. For removal of the non-attached PEI, the resulting greyish composite was washed and centrifuged five times with ddH2O (20000 RCF, −2° C., 10 min). For reference, a second solution was prepared following the same procedure but with non CAN-functionalized dNDs.

Attachment of Hyaluronic Acid (HA): 110 mg of HA were dissolved in 30 ml of ddH₂O. The solution was mixed in a VortexGenie2 automatic stirrer. 3 ml of the solution were added to a solution of dND-CAN (15 ml solution [dND]=1.06 g·L⁻¹). The solution containing dND-CAN NPs and HA was mixed for 1H. For removal of the non-attached HA, the resulting greyish composite was washed and centrifuged five times with ddH2O (20000, −2° C., 10 min). For reference, a second solution was prepared following the same procedure but with non CAN-functionalized dNDs.

Analysis by Design of Experiment: Design of Experiment (DoE) is a systematic method for evaluation of the relationship between factors affecting a process, and the output of that process, in order to optimize the output. The functionalization level of the dND surface by binding Ce^{3+/4+} cations/[Ce^{3+/4+}Ln] complexes has a critical importance regarding coordination capability and delivery of optimally surface-engineered dNDs. Because of this, DoE was applied to the experiments conducted. The object of the DOE was to reveal an optimal set of dND-CAN fabrication conditions that would result in a high and reproducible binding level.

An array of eighteen experiments was set up using the MINITAB® 16 DoE software (version 16.2.4, Minitab Inc.). The array is detailed in the following Table 2. Three main factors were chosen: time of sonication (10 min, 35 min, and 60 min), amplitude of sonication (20%, 40% and 60%) and CAN:dNDs ratio (1, 3.5, and 6). The design also included one factor replicate (one repetition of the experiments) and one center point.

TABLE 2
DOE samples and preparation

| | | | | CAN/ | | Sonication |
|---|---|---|---|---|---|---|
| Std | Run | Center | | dND | Amplitude | time |
| Order | Order | Pt | Blocks | ratio | % | (min) |
| 1 | 4 | 1 | 1 | 1 | 20 | 10 |
| 2 | 1 | 1 | 1 | 6 | 20 | 10 |
| 3 | 15 | 1 | 1 | 1 | 60 | 10 |
| 4 | 17 | 1 | 1 | 6 | 60 | 10 |
| 5 | 11 | 1 | 1 | 1 | 20 | 60 |
| 6 | 10 | 1 | 1 | 6 | 20 | 60 |
| 7 | 6 | 1 | 1 | 1 | 60 | 60 |
| 8 | 5 | 1 | 1 | 6 | 60 | 60 |
| 9 | 9 | 1 | 1 | 1 | 20 | 10 |
| 10 | 7 | 1 | 1 | 6 | 20 | 10 |
| 11 | 3 | 1 | 1 | 1 | 60 | 10 |
| 12 | 14 | 1 | 1 | 6 | 60 | 10 |
| 13 | 16 | 1 | 1 | 1 | 20 | 60 |
| 14 | 2 | 1 | 1 | 6 | 20 | 60 |
| 15 | 18 | 1 | 1 | 1 | 60 | 60 |
| 16 | 13 | 1 | 1 | 6 | 60 | 60 |
| 17 | 8 | 0 | 1 | 3.5 | 40 | 35 |
| 18 | 12 | 0 | 1 | 3.5 | 40 | 35 |

The experiments were randomized, in order to remove possible time related confounding effects. The DoE was only performed on the Ultrasonication method which proved to be more efficient and homogeneous than the microwave irradiation one. Regardless of ratio a fixed quantity of 20 mg dNDs was employed and the quantity of CAN was adjusted according to the ratio. The apparatus used for sonication is a VIBRACELL VC 750/750 watts·250 μl—liters with a high gain 13 mm probe.

The 18 experiments listed in table 2 provided quantified responses (reaction outcomes), i.e., the average DLS hydrodynamic size of resulting CAN-dND NPs with polydispersity index (PDI), the average Ce ICP concentration, and the average ζ-potential. The output values are discussed hereinbelow.

### Results and Discussion

Disaggregation of dND clusters: The reason for using oxidation-related disaggregation methods (Graphitization-Oxidation and Oxidation) was the assumption that aggregation of dNDs in aqueous media is caused by their hydrophobicity. Oxidation should lead to the formation of hydrophilic groups on the surface of dNDs, improving their dispensability in water. Yet, oxidation can also have a side effect in the form of hydrogen bonds, causing a secondary aggregation. Samples of all disaggregation treatments were characterized by DLS. The oxidized ones were additionally characterized by FTIR, Raman, and potential (zeta potential).

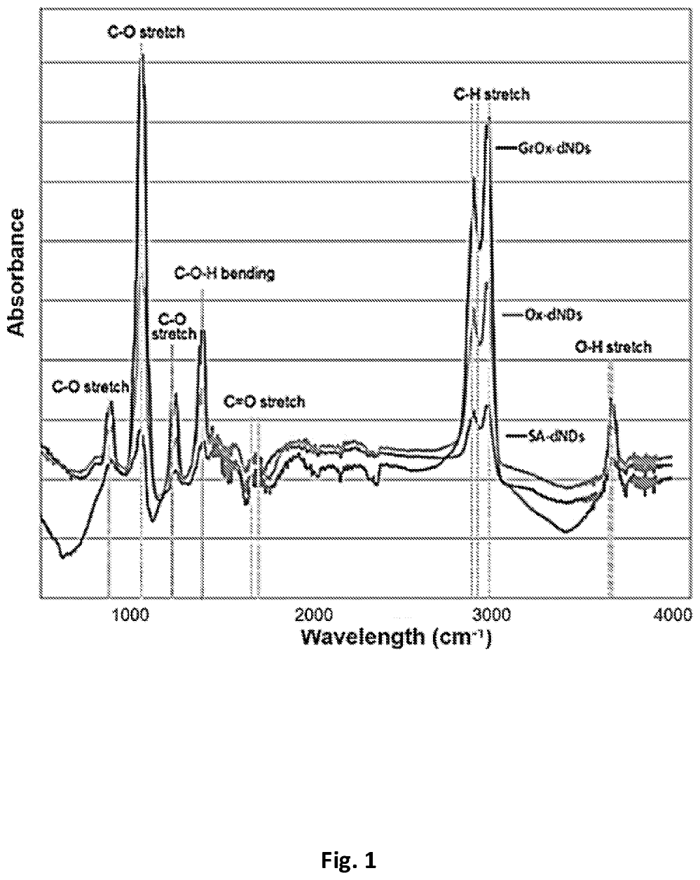

FIG. 1 shows FTIR spectra of dNDs (SA-dNDs,), Graphitized-oxidized dNDs (GrOx-dNDs,), and Oxidized dND (Ox-dNDs). FTIR absorbance spectra (FIG. 1) of the pristine dNDs (SA-dNDs) and the two oxidized samples (Ox-dNDs and GrOx-dNDs) look similar, having peaks at the same positions but with different intensities. The spectra suggest the presence of primary, secondary, and tertiary alcohols having their O—H stretch peaks 3600 cm⁻¹, their C—O stretch peaks at 780-800 cm⁻¹ and 1050-1150 cm⁻¹, and their O—H bending peaks at ˜1350 cm⁻¹. These results suggest some level of surface oxidation, even prior to the treatments (as evidenced by SA-dNDs plot). Nonetheless, there are a few noteworthy differences between the spectra. The ratio between the peak at approximately 1100 cm⁻¹ and the rest of the spectrum is noticeably higher for the oxidized samples. This peak is assigned to alcoholic and etheric C—O stretches. In all spectra, there are two overlapping peaks at the C—H stretching zone (2750-3000 cm⁻¹). One of which, at approximately 2800 cm⁻¹ may be assigned to the C—H stretch in —O—C—H groups. The other, at approximately 3000 cm⁻¹, may be assigned to aliphatic C—H stretches. The latter is slightly higher for the spectrum of the Graphitization-Oxidation sample (GrOx-dNDs), which make sense, as graphitization is a reductive process.

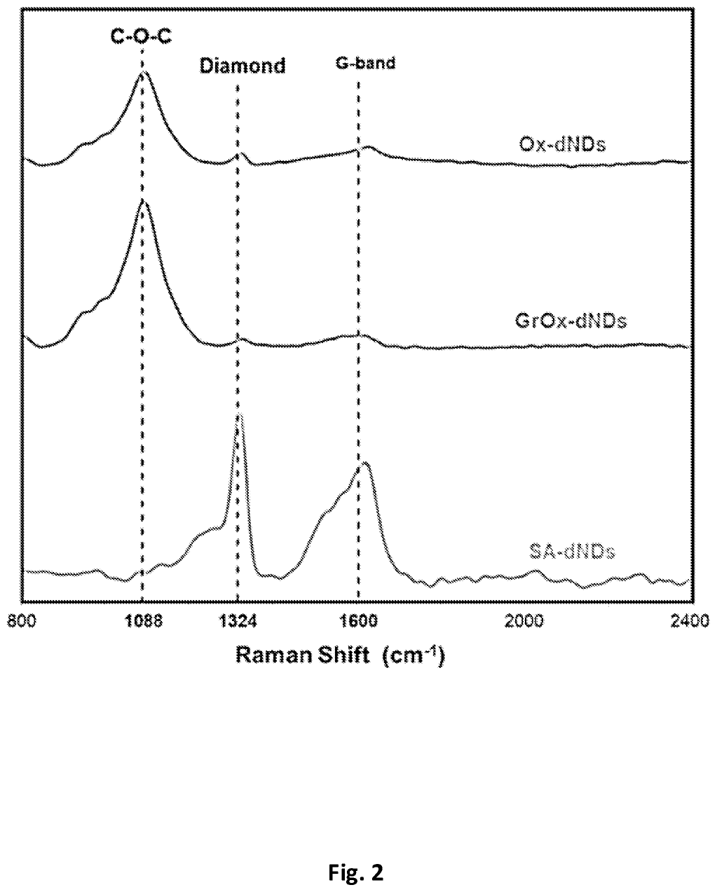

The oxidation of the dNDs surface is confirmed by Raman (FIG. 2). FIG. 2 shows Raman spectra of pristine dNDs (SA-dNDs), Graphitization-Oxidation dNDs (GrOx-dNDs), and Oxidation dNDs (Ox-dNDs). All spectra show the G-band, characteristic to carbon-based material, at 1600 cm⁻and the typical D-band of diamond at 1324 cm⁻¹. For the oxidized samples, these peaks are overshadowed by a strong peak at 1088 cm⁻¹. This Raman shift corresponds to C—O—C, correlating with the FTIR spectra.

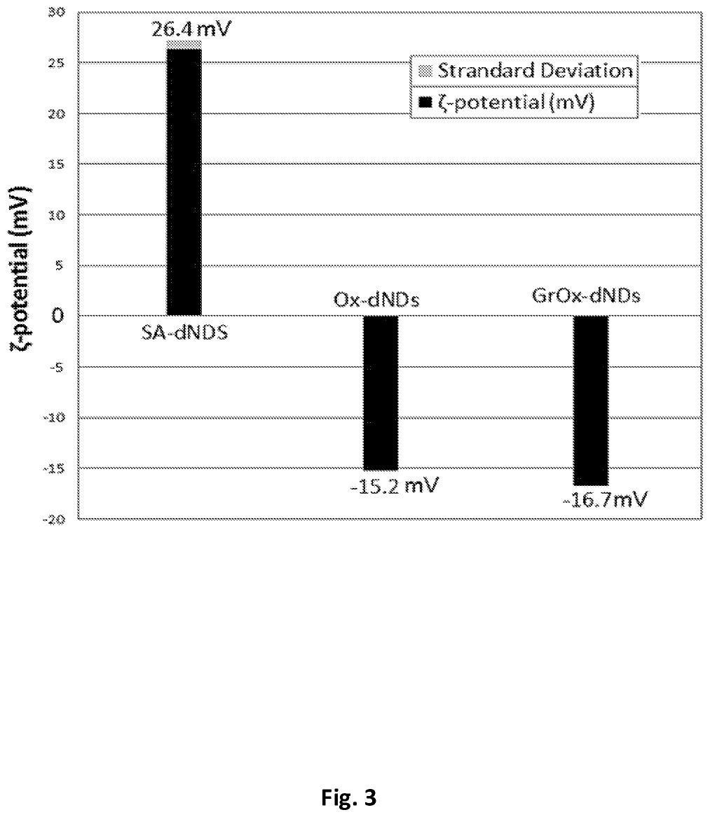

ζ-potential (zeta potential) measurements can also indicate surface oxidation. While the absolute value of the ζ-potential is usually used as an indicator for stability of colloidal solutions, a change of sign after treatment can result from a chemical change in the surface. FIG. 3 shows ζ-potential data for samples Ox-dNDs, GrOx-dNDs, and SA-dNDs. FIG. 3 demonstrates such a change of sign: pristine dNDs have a ζ-potential of +26.4 mV and after oxidation the value becomes negative (−15.2 mV and −16.7mV for Ox-dNDs and GrOx-dNDs, respectively). The ζ-potential of dNDs is reportedly about +20 eV. Positive ζ-potential values in dNDs can be attributed to the presence of graphitic planes impurities at the surface, which leave oxygen-free Lewis sites, thus promoting the suppression of acidic functional groups. This explains why, although the FTIR spectra show the presence of oxygen-containing groups on the pristine dNDs, the ζ-potential is significantly positive. After treatment, the quantity of surface oxygens increases dramatically, making the net charge of the dNDs negative.

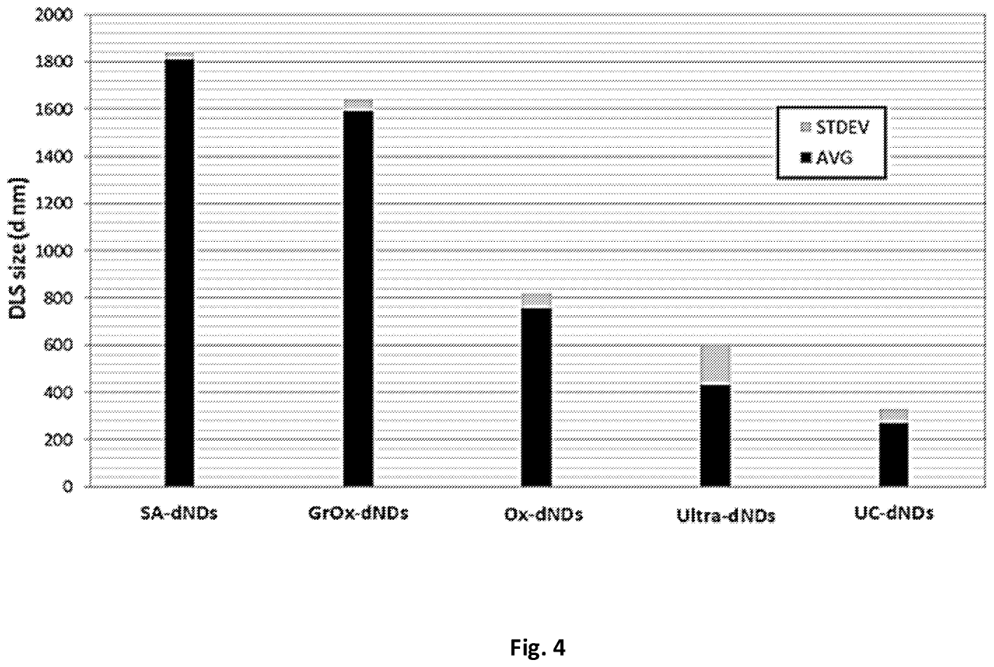

FIG. 4 shows DLS particle size data for pristine NDs and for deagglomerated NDs. DLS measurements describe the evolution of the aggregate size following different treatments. All the treatments resulted in size reduction with a maximum of 80% for Ultrasonication. Still, the size of dNDs clusters remained above the nanometric domain (1-100 nm). This obstacle was circumvented by the Ultrasonication-Centrifugation treatment, which resulted in a transparent solution of ultradispersed 10-20 nm (HR-SEM, not shown) 200-300 nm (DLS, FIG. 10) sized NPs. The difference between the size in DLS and in HR-SEM is due to the fact that the DLS measures the hydrodynamic diameter of NPs in solution while HR-SEM measures the real size of the dry NPs. It appears that CAN-modified dNDs (f-dNDs) are less agglomerated and have a better dispersion stability than the non-modified dNDs as explained hereinbelow.

Binding dNDs with CAN

In order to identify and characterize CAN-dNDs, TGA, EDAX, ICP, Elemental analysis, and ζ-potential measurements were employed.

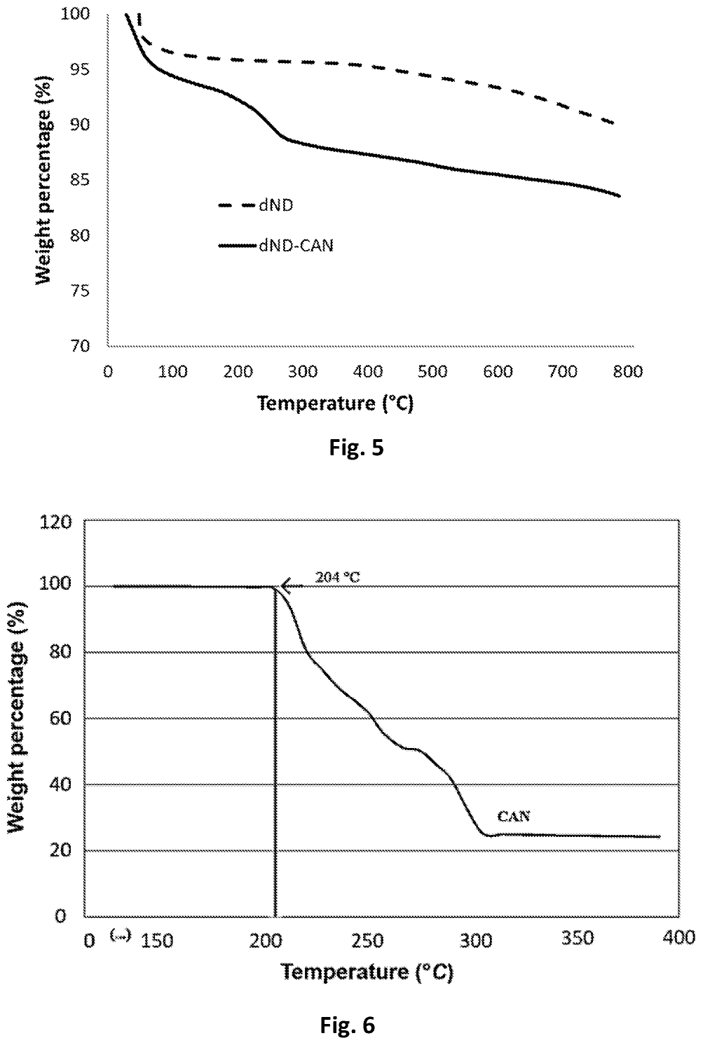

FIG. 5 shows Thermogravimetric analyses (TGA) of pristine dND (SA-dNDs) vs. CAN-modified dNDs (f-dNDs). FIG. 6 shows TGA analysis for Ceric Ammonium Nitrate [CAN, Ce^{IV}(NH₄)₂(NO₃)₆]. TGA showed a gradual 9% weight loss for the untreated SA-dNDs, over a wide range of temperatures. This weight loss can be attributed to surface impurities, some of which are embedded in the dNDs aggregates. The CAN-modified f-dNDs show a 16% weight loss. Since the samples were heated up to 800° C., and that the diamond core of the ND does not melt below 3550° C., the 7% weight loss difference must originate from the outer shell; it indicates the presence of CAN molecules or residues. Moreover, in the graph of the CAN-modified f-dNDs, the main weight decrease occurs at around 200° C., as in the TGA plot for pure CAN (FIG. 6).

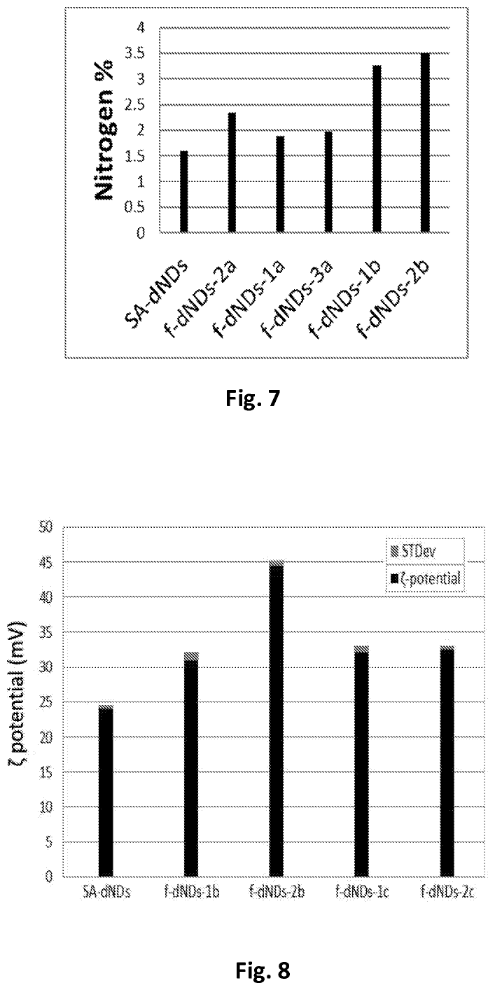

FIG. 7 is an elemental analysis bar graph indicating the percentage of Nitrogen in NDs treated in various ways. FIG. 7 shows an increased presence of nitrogen in the CAN-functionalized f-dNDs, compared to untreated SA-dNDs. The increase of the concentration of nitrogen provides indirect evidence for the presence of CAN, since the only source of available nitrogen is the nitrate ligands in CAN. Samples f-dNDs-1b and f-dNDs-2b showed higher nitrogen content compared to samples f-dNDs[1-3]a.

For the preparation of f-dNDs-1b and f-dNDs-2b, CAN was dissolved in water while for the preparation of f-dNDs[1-3]a, CAN was dissolved in acetone.

Results summarized in FIG. 7 suggest acetone is unnecessary, and dispersion of CAN in water was more efficient.

FIG. 8 is a bar graph of ζ-potential of CAN-modified dNDs samples vs. a control sample (SA-dNDs). The ζ-potential analysis was used to evaluate the attachment of CAN to the surface of the dNDs. Binding the surface with cerium through CAN increases the positive charge.

Indeed, all CAN-modified dNDs showed higher ζ-potentials, with a maximum of +44±0.8 mV for the sampled prepared by 1 h ultrasonication (f-dNDs-2b). The results for samples prepared by sonication were also more reproducible compared to those of preparation by microwave irradiation.

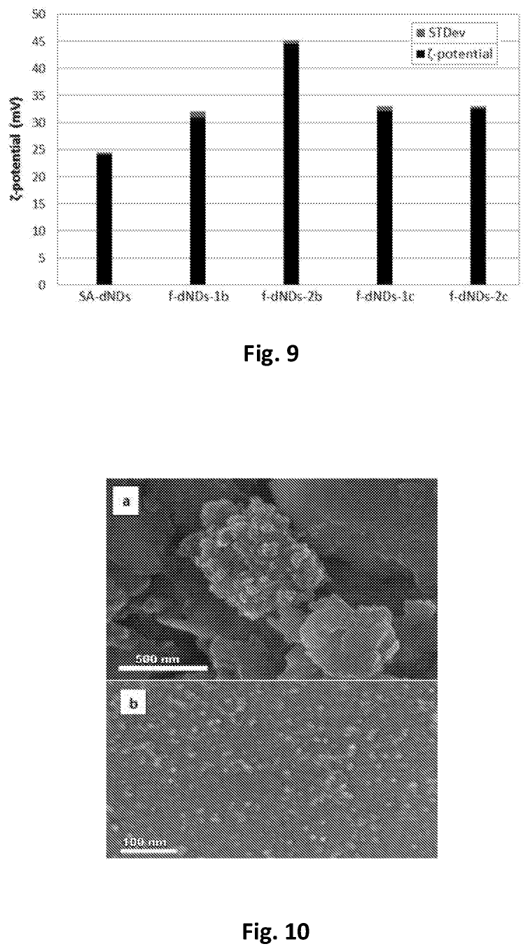

FIG. 9 is a bar graph of inductively coupled plasma (ICP-MS) measurements for ultrasonication samples (f-dNDs-1b and f-dNDs-2b) and previously oxidized ultrasonication samples (f-Ox-dNDs-1b). The ICP data further highlight and confirm the presence of elemental cerium. The analysis also confirms than 1 h ultrasonication is preferable on ½ hour, resulting in higher Ce loads. ICP measurements of samples oxidized before the attachment (f-Ox-dNDs-1b), yielded higher quantity of cerium than non-oxidized dNDs (0.38±0.002% and 0.26±0.002%, respectively). This important detail gives insights about the interaction between the dNDs surface and the CAN complex. One possible explanation is ligand-exchange between the Ce-based complex and the oxidized surface of the dNDs.

FIG. 10 is HR-SEM micrographs of (a) Pristine dNDs and (b) f-dNDs-2b. CAN-modified dNDs (f-dNDs) were less agglomerated as seen in the HR-SEM images comparing pristine dNDs to CAN-modified ones. The pristine dNDs (a) form large clusters (hundreds of nanometers long).

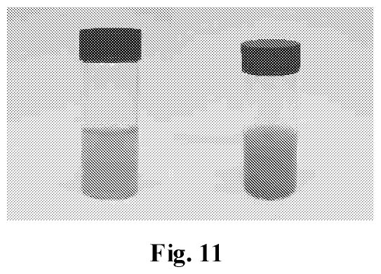

In sharp contrast, the CAN-modified dNDs (b) are more evenly spread and less aggregated. Individual 10 nm sized particles can be observed. From the HR-SEM images and ζ-potential values, it can be concluded that CAN-mediated modification also has a disaggregating effect on the dNDs. This may be due to the repulsion between the now-positively charged dND particles. Aqueous dispersions of CAN-modified dNDs had a good stability, but still appeared opaque. Clear dispersions were obtained by using previously UC-disaggregated CAN-modified dNDs as seen in FIG. 11.

FIG. 11 shows a clear solution (left) of CAN-modified dNDs with NPs resulting from the ultrasonication-centrifugation technique. A turbid solution (right) of CAN-modified dNDs resulted from non-disaggregated dNDs. A pink syringe filter was placed behind both samples. These pictures suggest a synergy between the disaggregation and the CAN modification in their contribution to more stable dispersions of dNDs.

### Design of Experiment (DoE)

As mentioned above, the outputs for the DoE optimization were the ζ-potential, the particles size (DLS), and the cerium concentration (ICP). First, all the NPs obtained were strongly positively charged in a +28.0 to +34.3 mV range of ζ-potential values (Table 3).

TABLE 3
DoE results

| Run | Ce by ICP | StDev | DLS size | | ζ-potential |
|---|---|---|---|---|---|
| Order | (ppm) | (ICP) | (nm) | PDI | (mV) |
| 1 | 39.618 | 0.301453 | 231.4 | 0.371 | +34.3 |
| 2 | 34.153 | 0.181536 | 189.1 | 0.277 | +31.1 |
| 3 | 14.348 | 0.092449 | 200.4 | 0.309 | +29.7 |
| 4 | 8.684 | 0.06224 | 187.23 | 0.309 | +29.7 |
| 5 | 42.839 | 0.314376 | 195.6 | 0.265 | +34.3 |
| 6 | 16.341 | 0.081335 | 168 | 0.248 | +27.4 |
| 7 | 46.965 | 0.26529 | 229.4 | 0.404 | +31 |
| 8 | 38.948 | 0.185982 | 192.4 | 0.33 | +29.3 |
| 9 | 15.012 | 0.095659 | 207.2 | 0.3 | +26.2 |
| 10 | 46.594 | 0.239708 | 206.4 | 0.329 | +32 |
| 11 | 13.148 | 0.053959 | 207.2 | 0.3 | +26.2 |
| 12 | 33.369 | 0.175488 | 200.9 | 0.253 | +28.5 |
| 13 | 42.467 | 0.885912 | 174.4 | 0.248 | +27.9 |
| 14 | 33.952 | 2.012 | 205.1 | 0.278 | +30.9 |
| 15 | 14.68 | 0.031841 | 192.6 | 0.247 | +26.5 |
| 16 | 18.559 | 0.04905 | 180.4 | 0.252 | +27.2 |
| 17 | 52.183 | 0.195304 | 201.3 | 0.276 | +31.7 |
| 18 | 16.795 | 0.515808 | 165.3 | 0.207 | +28 |

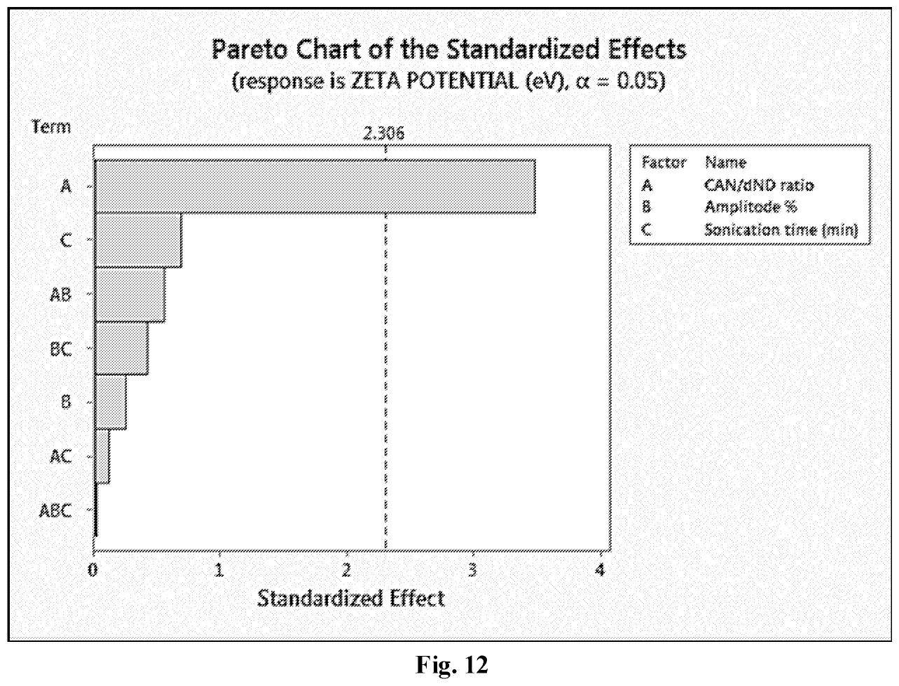

These data are indicative of an overall successful binding process by Ce^{3+/4+} cations/CAN complexes. The CAN oxidant amount was the most influential of all three investigated factors. This was found using a Paretto chart of standardized effects (FIG. 12). The dotted vertical line in a Pareto indicates the statistical significance of a factor.

FIG. 12 is a Pareto chart of the DoE for ζ-potential. In FIG. 12, the only factor that crossed the red line was the ratio CAN:dND, meaning that this ratio is the only one affecting the ζ-potential. The optimization software Minitab creates the main effects plot by plotting the means for each value of a categorical variable. A line connects the points for each variable. By looking at the line one can determine whether a main effect is present for a categorical variable. When the line is parallel to the reference line, there is no main effect present. The response mean is the same across all factor levels. When the line is not horizontal, there is a main effect present. The response mean is not the same across all factor levels. The steeper the slope of the line, the greater is the magnitude of the main effect.

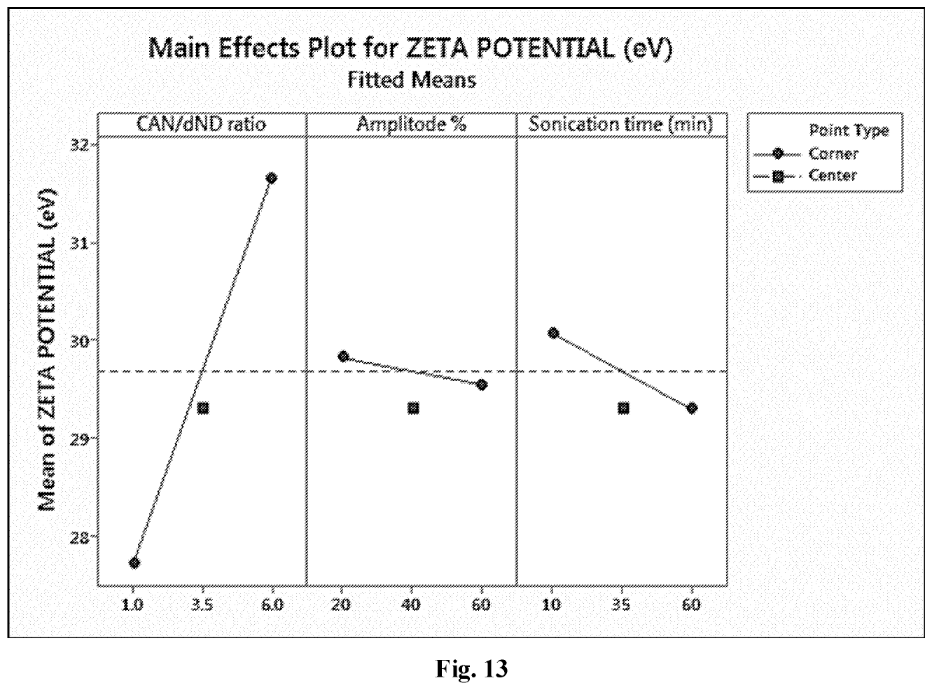

FIG. 13 is a main effects plot for ζ-potential. The main effects plot for ζ-potential shows once again that the most important factor is the CAN:dNDs ratio. It is also interesting to notice that although the sonication time has a smaller effect, it is a negative one: the longer the sonication time, the lower is the ζ-potential.

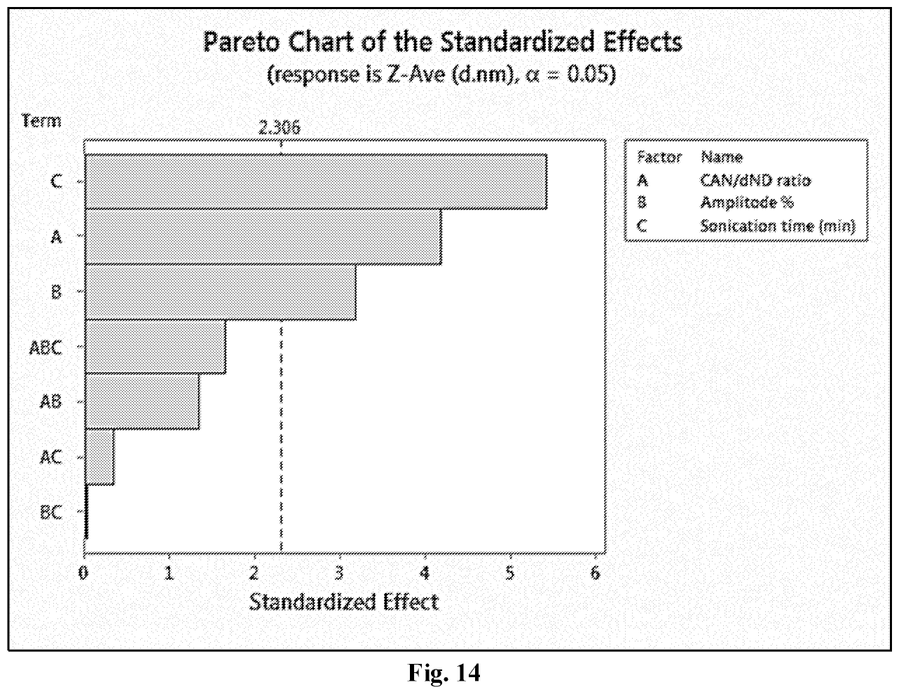

FIG. 14 is a Pareto chart for DLS size. This Pareto chart in FIG. 14 shows that all three factors affect the particles size, but each of them only contributes individually. The most influential factor is the sonication time, and from the main effects chart, one can see that the longer the sonication time, the smaller are the particles.

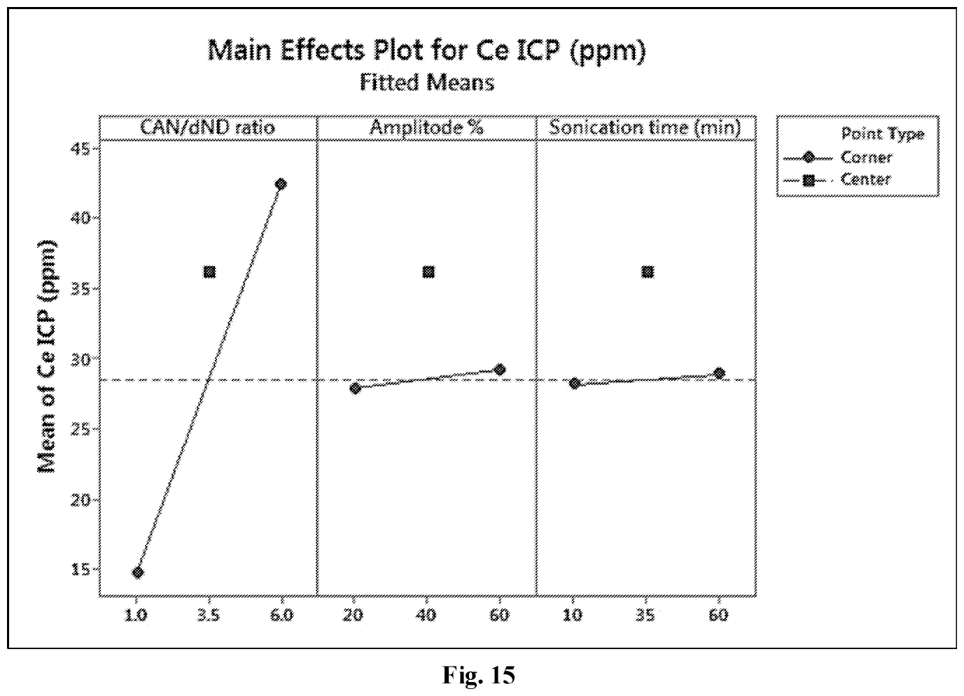

FIG. 15 is a main effect plot for Ce concentration which shows that the ratio CAN:dND is the only factor of the resulting CAN concentration. Even though it makes sense in theory that the more one adds the more one gets, in practice the samples were carefully washed. The most efficient ratio was also the highest value inputted, which suggests the loading limit has not been reached. Higher ratios were examined to find the loading limit which appears to be at a ratio of 10.

### Second Step Functionalization

In order to determine how CAN modification of NDs affects attachment of additional reactive groups, binding of PEI and Hyaluronic Acid was assayed. In addition to the reasons mentioned above, PEI was chosen for its potential to chelate with cerium, and its biomedical potential for further attachment of biologic molecules (RNA, DNA, etc.). Hyaluronic acid is also a good ligand for coordinative chemistry, especially in its conjugate base (Hyaluronate) form. Hyaluronic Acid was chosen for its importance in cosmetics. Since NDs have the ability of high dermal absorption, they could potentially improve penetration of existing creams to the skin. We compared the attachment to sample f-dNDs with dNDs (non-CAN-modified dNDs). Attachment of PEI was verified by FTIR, TGA and HR-TEM. Attachment of HA was verified by TGA.

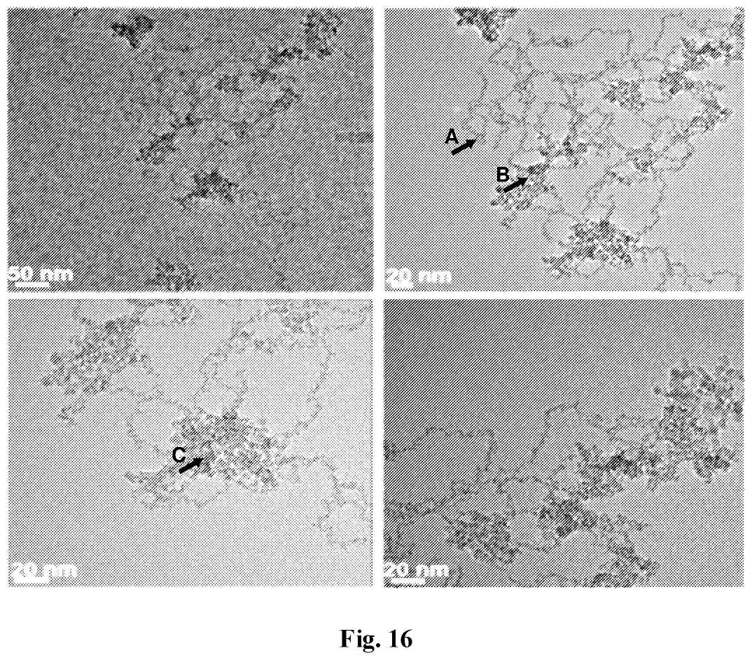

HR-TEM images (FIG. 16) show the resulting f-dNDs-PEI25. We can see a strong contrast between the cerium NPs (B arrow), and the small 4-20 nm dNDs (C arrow). The cerium is localized on the dNDs. Recognizable b-PEI25 (arrow A) chains are observed around and between the CAN-dNDs domains.

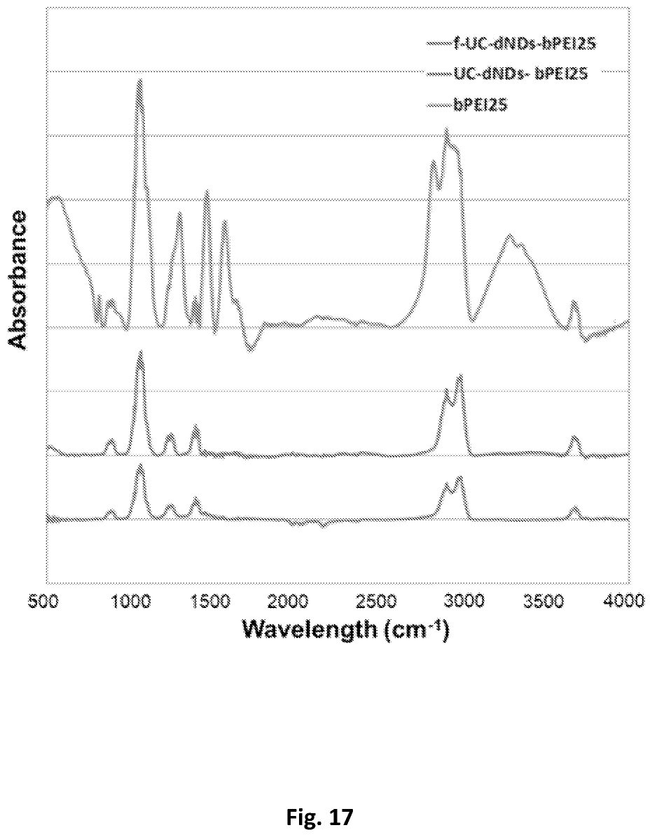

FIG. 17 shows FTIR spectra for bPEI25 (top), UC-dNDs-bPEI25 (middle), and f-UC-dNDs-bPEI25 (bottom). The FTIR spectra show a typical spectrum of pristine bPEI25, and the spectra of PEI-functionalized dNDs samples. Bending vibrations of amine groups contribute in the region around 1450-1650 cm⁻¹, and are especially intense in the case of PEI (1456 cm⁻¹). The absorptions at 1040-1070 cm⁻¹ are associated with C—N stretch. From the spectra it seems that PEI is attached to both dNDs samples. However, as their spectra look similar, there is no clear indication that CAN has a role in this attachment.

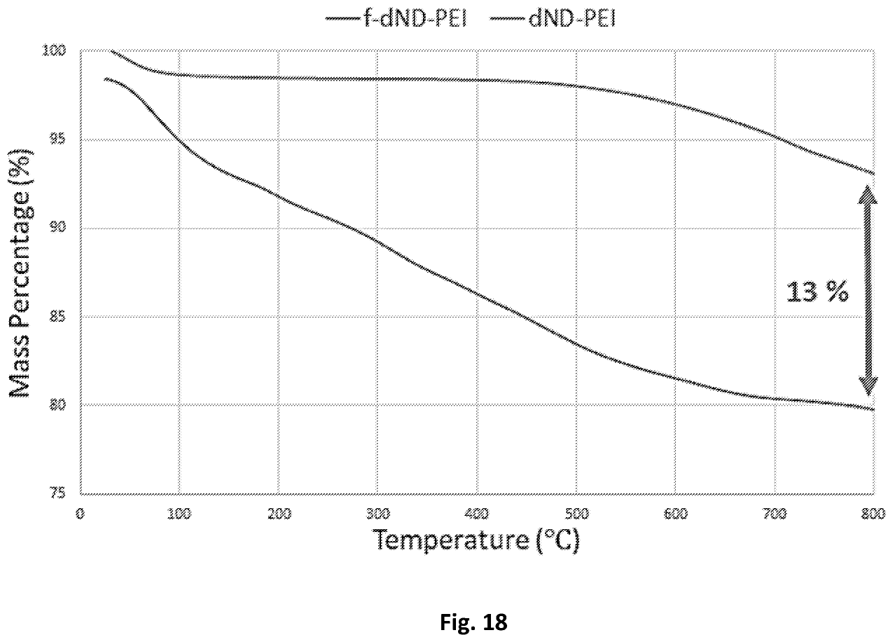

FIG. 18 shows a thermogravimetric analyses (TGA) curve, PEI attachment to dNDs with and without CAN. The TGA data shows a gradual 6.9% weight loss for the non CAN-modified, PEI-dNDs, over a wide range of temperatures. This weight loss can be attributed to surface impurities, and to some of which are embedded in the dNDs aggregates. The CAN-modified dNDs show a 16% weight loss. Since the samples were heated up to 800° C., and that the diamond core of the ND does not melt below 3550° C., the 7% weight loss difference must originate from the outer shell; it indicates the presence of CAN molecules or residues. Moreover, in the graph of the CAN-modified dNDs (f-dNDs), the main weight decrease occurs at around 200° C., as in the graph of pure CAN (FIG. 6).

The same observation can be drawn from a comparative TGA of the PEI-modified dNDs samples (FIG. 18). TGA of dNDs-bPEI25 shows a weight loss of about 13%, in a temperature interval of 250-550° C. The plot shows three drops while the plot of UC-dNDs-PEI25 shows two. The difference between TGA behavior of f-dNDs-bPEI25 and dNDs-PEI25 can be explained by the composition of the particles. dNDs do not decompose below 800° C., so the three weight drops for f-dNDs-bPEI25 can be explained as follows:

the first is for the water (below 150° C.),

the second is for CAN and

the third is for PEI.

The two drops for dNDs-bPEI25 can be attributed to water and PEI.

The weight loss difference between dNDs-bPEI25 and f-dNDs-bPEI25 is only 1%, so once again the analysis does not suggest that PEI binds preferentially to the CAN functionalized dNDs.

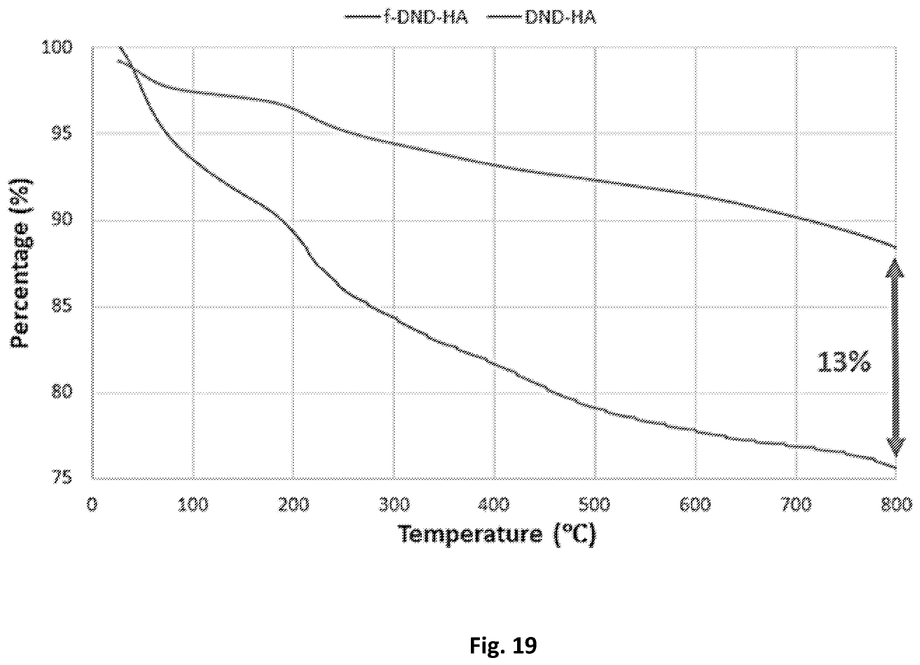

FIG. 19 shows a TGA curve for HA attachment to dNDs with and without CAN. Based on the TGA curve of FIG. 19, the exact same conclusions can be drawn for the f-dND-HA particles.

The above description compares between different disaggregation methods for dNDs, presents an inorganic functionalization pathway for dNDs and suggests that additional functional groups such as PEI and/or HA can be attached to dNDs.

Conclusions for dNDs:

Ultrasonication appears to be more efficient at disaggregation of dNDs than chemical Oxidation methods. Adding a step of size-excluding centrifugation to the Ultrasonication method (UC) further improved disaggregation.

CAN modification of the dNDs also had a disaggregating effect on the dNDs. A combination of the UC method with CAN modifications gave the desired result of nanometric dNDs.

Preliminary CAN-modification experiments subjected to a DoE matrix suggest the optimal protocol for CAN attachment to dNDs is CAN dissolved in water, 1 h ultrasonication, and a CAN:dNDs ratio of 10.

Implementation of the above protocol produced CAN-dNDs particles with a size of 10-20 nm that formed clear and stable dispersions in water (+35 to +45 mV by ζ-potential).

CAN treatment of dNDs had a positive effect on subsequent PEI and/or HA attachment.

Results for Additional Experiments with Naturally Occurring NDs

Treatment of natural NDs with CAN oxidant was conducted on samples in both micrometric and nanometric size ranges (from 250 nm to more than 30 microns) in order to confirm that protocols suitable for dNDs are suitable also for natural NDs.

Ultrasonication was performed as described hereinabove and proved to be an effective methodology.

Initially, natural diamonds with a maximum size of 250 nm were tested. After the first sonication treatment, a transparent solution of ultradispersed particles of about 170 nm for hydrodynamic diameter, according to the DLS measurement was produced. This treatment resulted in size reduction of approximately 60% for the ultrasonication step (initial size was 417 nm by DLS). The stability of the surface-engineered diamonds solution is proved by the ζ-potential measurement that doubles in absolute value (from −11.1 mV to −22.1 mV). The next step was binding of cerium cations/complexes onto the surface with the use of CAN oxidant during the second ultrasonication treatment of 1 hour. All CAN-modified NDs showed higher ζ-potentials with a maximum of +47.3 mV and diameter size of 185 nm according to DLS measurements.

In a subsequent experiment, natural diamonds in the micrometric range (maximum size of 30 microns) were sonicated using the same protocol. With these larger diamonds a grey solution was obtained after the first sonication process, probably due to the presence of bigger particles. Still, the size of the natural diamonds remained above the nanometric domain (≥100 nm). Only after the second ultrasonication procedure, when Cerium was attached to the nanodiamond particles, the solution became transparent. Clarification of the solution indicates that the size was reduced to nanometric range. The diameter size and ζ-potentials of the NDs obtained was 150 nm and 48.8 mV, respectively. The results for samples prepared by sonication shown NDs with a very high stability in water solution and size reduction of more than 50% (by DLS) relative to the natural diamonds particles before treatment.

For all cases, individual 7-9 nm sized particles are observed in TEM images (not shown). These experiments demonstrate that can be concluded that CAN-mediated modification has a disaggregating effect on natural NDs as well as on dNDs.

1. A disaggregation method for nanodiamonds (NDs) comprising:
(a) sonicating NDs dispersed in water; and
(b) sedimenting non-disaggregated NDs by centrifugation.

2. The method according to claim 1, wherein said centrifugation is at 20000 RCF for at least 10 minutes.

3. The method according to claim 1, comprising:
sonicating the disaggregated NDs with CAN [(NH₄)₂Ce(NO₃)₆] to produce CAN modified NDs; and
washing to remove excess CAN.

4. A population of CAN modified NDs having a size of 10-20 nm.

5. The population of CAN modified NDs according to claim 4, provided as a clear dispersion in water.

6. The population of CAN modified NDs according to claim 4 characterized by ζ-potential of +35mV to +50 mV.

7. The method according to claim 1 wherein said NDs comprise dNDs (detonation nanodiamonds).

8. The population of CAN modified NDs according to claim 4 wherein said NDs comprise natural NDs.
